(19) United States
(12) Patent Application Publication
(10) Pub. No.: US 2013/0070829 A1
(43) Pub. Date: Mar. 21, 2013

(54) SAMPLING PHASE CALIBRATING METHOD, STORAGE SYSTEM UTILIZING THE SAMPLING PHASE CALIBRATING METHOD

(71) Applicants: Neng-Hsien Lin, Hsinchu County (TW); Guobing Jiang, Suzhou City (CN)

(72) Inventors: Neng-Hsien Lin, Hsinchu County (TW); Guobing Jiang, Suzhou City (CN)

(21) Appl. No.: 13/609,243

(22) Filed: Sep. 10, 2012

(30) Foreign Application Priority Data
Sep. 21, 2011 (CN) 201110282245.4

(51) Int. Cl. H04B 17/00

(52) U.S. Cl. 375/226

(57) ABSTRACT

A sampling phase calibrating method, comprising: transmitting a second command signal from a storage device controller, to read content in a storage device; transmitting a first command signal and a third data signal with a third sampling phase from the storage device controller to the storage device, according to the content; and determining if data transmitting from the storage device controller to the storage device has error, according to responding information that the storage device responds to the storage device controller corresponding to the first command signal and the third data signal, to determine if the third sampling phase is suitable; wherein the second command signal is transmitted via a second clock, the first command signal is transmitted via a first clock, where the second clock is slower than the first clock.

### BACKGROUND OF THE INVENTION

1. Field of the Invention

The present invention relates to a sampling phase calibrating method and a storage system utilizing the sampling phase calibrating method, and particularly relates to a sampling phase calibrating method for the timing that the data is written from the storage system controller to the storage system, and a storage system utilizing the sampling phase calibrating method.

2. Description of the Prior Art

Conventionally, a SD (Secure Digital) storage device includes a SD card controller and a SD memory card. The communication signals between both include: a clock signal (CLK), a command signal (CMD) and a data signal (DAT). Based on the specification of SD card, the transmitting and receiving for the command signal and the data signal must be synchronized with a clock signal provided by the controller. Also, a specific phase relation must exist between the command signal and the data signal, or the transmitting will be incorrect and thereby the communication between the controller and the SD memory card may fail. FIG. 1 is a schematic diagram illustrating prior art data sampling operation. As shown in FIG. 1, the best sampling phase for the receiving terminal is at “10”. On the contrary, “0”, “1”, “n−1”, “n” are the worst phases, which may cause error while sampling data.

There are two factors affecting data transmitting accuracy for the storage device. One factor is data transmitting speed. Valid data sampling range becomes smaller if the data transmitting is faster (ex. the valid data range in FIG. 1). Also, data sampling error easily occurs for either the transmitting side or the receiving side. However, the data sampling range becomes smaller when the speed of SD memory card increases. For example, SD 3.0 utilizes the UHS-I transmitting mode, thereby the clock signal frequency can reach 208 MHz. Therefore, data sampling may have error even if the sampling point has just few shifts. The other factor is the signal transmitting path. Phase relations between the command signal, the data signal and the clock signal may have difference corresponding to the variation of the signal transmitting line lengths and resistance values between circuit boards. Accordingly, data transmitting error may easily occur due to their phase variations.

FIG. 2 is a schematic diagram illustrating a prior art SD storage device and the operating for writing data (TX) and reading data (RX) for the SD storage device. As shown in FIG. 2, the SD storage device includes a SD card controller 201 and a SD memory card 205. The signal transmitting has different processing mechanism for “writing” data and “reading” data. During a data writing process, the clock signal, the command signal and the data signal are toward the same direction, thus the phases thereof are relatedly easily to control. Practically, if the transmitting speed is high, transmitting failure may occur due to the low transmitting quality caused by environment factors such as the layout or resistance of the circuit boards. Thus, practically it is hard to utilize a fixed phase to perform stable transmitting in different environments. However, the SD spec does not provide a suitable mechanism for fixing such problem.

During a data reading process, the SD card controller sends clock/command signals to the SD memory card first, and then the SD card responses corresponding data after receiving the clock/command signals. The delay time between the timing that the SD card controller sends clock/command signals and the timing that the SD card controller receives the response from the SD memory card is 2*(T_{pad}+T_{pcb}). T_{pad} is the internal signal delay plus the signal delay caused by pads such as 202, 204. Also, T_{pcb} is the signal delay caused by the printed circuit board layout 203. These kinds of delay time may become unpredictable due to the different circuit boards and pads, and other environment factors such as temperature. If the effect that the valid data range becomes smaller due to high clock frequency is further concerned, the SD card controller may easily lose correct data from the SD memory card. SD 3.0 has provided a method to improve such isse, which utilizes a command signal CMD 19 to perform related tests, to determine if the current signal sampling phase can correctly read data or not. However, the SD storage device can not support CMD19 in the DDR transmitting mode, thus can not utilize CMD19 to perform related tests. Besides, the phase testing for either the data writing or the data reading must depend on correct command signal. That is, the command signal must be correctly received. However, SD 3.0 and related technology never mentions such issue.

### SUMMARY OF THE INVENTION

Therefore, one objective of the present invention is to provide a sampling phase calibrating method for data writing.

Another objective of the present invention is to provide a sampling phase calibrating method for a command signal.

Another objective of the present invention is to provide a sampling phase calibrating method for data reading.

One embodiment of the present invention discloses a sampling phase calibrating method, comprising: transmitting a second command signal from a storage device controller, to read content in a storage device; transmitting a first command signal and a third data signal with a third sampling phase from the storage device controller to the storage device, according to the content; and determining if data transmitting from the storage device controller to the storage device has error, according to responding information that the storage device responds to the storage device controller corresponding to the first command signal and the third data signal, to determine if the third sampling phase is suitable; wherein the second command signal is transmitted via a second clock, the first command signal is transmitted via a first clock, where the second clock is slower than the first clock.

Another embodiment of the present invention discloses a sampling phase calibrating method, comprising: transmitting a third command signal from a storage device controller to a storage device; selecting a command sampling phase via changing time periods for a high level and a low level of the third command signal, and based on a response that the storage device responds to the storage device controller corresponding to the third command signal; transmitting a first command signal from a storage device controller with the command sampling phase to a storage device; controlling the storage device to respond response information to the storage device controller via a command signal line; transmitting third data with a third sampling phase from the storage device to the storage device controller as third received data, via a data line; and determining if the storage device controller correctly receives signals from the storage device according to the responding information and the third received data, to determine if the third sampling phase is suitable.

Still another embodiment of the present invention discloses a storage system, comprising: a storage device; and a storage device controller, for transmitting a second command signal to read content in the storage device, and for transmitting a first command signal and a third data signal with a third sampling phase to the storage device, according to the content, to determine if data transmitting from the storage device controller to the storage device has error, thereby determining if the third sampling phase is suitable; wherein the storage device controller transmits the second command signal via a second clock, and transmits the first command signal via a first clock, where the second clock is slower than the first clock.

In view of above mentioned embodiments, the present invention provides a sampling phase calibrating method for data writing, to improve the defect of that prior art does not calibrating the sampling phase for data writing. Also, the command signal sampling phase calibrating method and the sampling phase for data reading are also provided. By this way, the data writing or reading can both be more accurate.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating prior art data sampling operation.

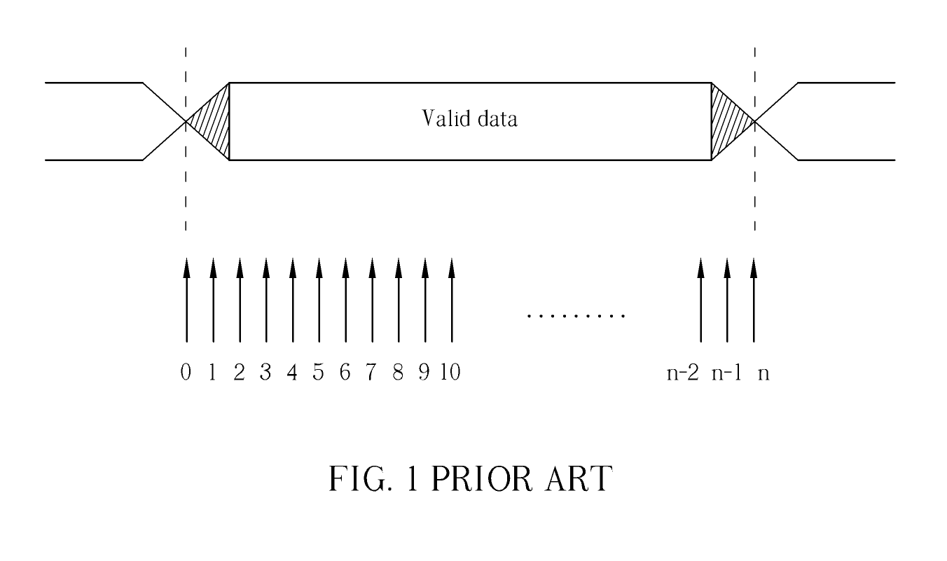

FIG. 2 is a schematic diagram illustrating a prior art SD storage device and the operating for writing data (TX) and reading data (RX) for the SD storage device.

FIG. 3 is a schematic diagram illustrating a command signal sampling phase calibrating method according to one embodiment of the present application.

FIG. 4 is a flow chart illustrating a command signal sampling phase calibrating method according to one embodiment of the present application.

FIG. 5 is a schematic diagram illustrating prior art relations between the clock signal, the command signal and the data signal.

FIG. 6 is a flow chart illustrating a sampling phase calibrating method for data writing according to one embodiment of the present application.

FIG. 7 is a flow chart illustrating a sampling phase calibrating method for data reading according to one embodiment of the present application.

FIG. 8 is a schematic diagram illustrating how to select a proper sampling phase.

FIG. 9 is a schematic diagram illustrating a SD storage device according to one embodiment of the present application.

### DETAILED DESCRIPTION

In the following embodiments, the present invention respectively provide a command signal (CMD) sampling phase calibrating method, a data sampling phase calibrating method for writing data (i.e. TX) and a data sampling phase calibrating method for reading data (i.e. RX). Those skilled in the art will readily observe that numerous modifications and alterations of the device and method may be made while retaining the teachings of the invention. Such variation should also be included in the scope of the present invention.

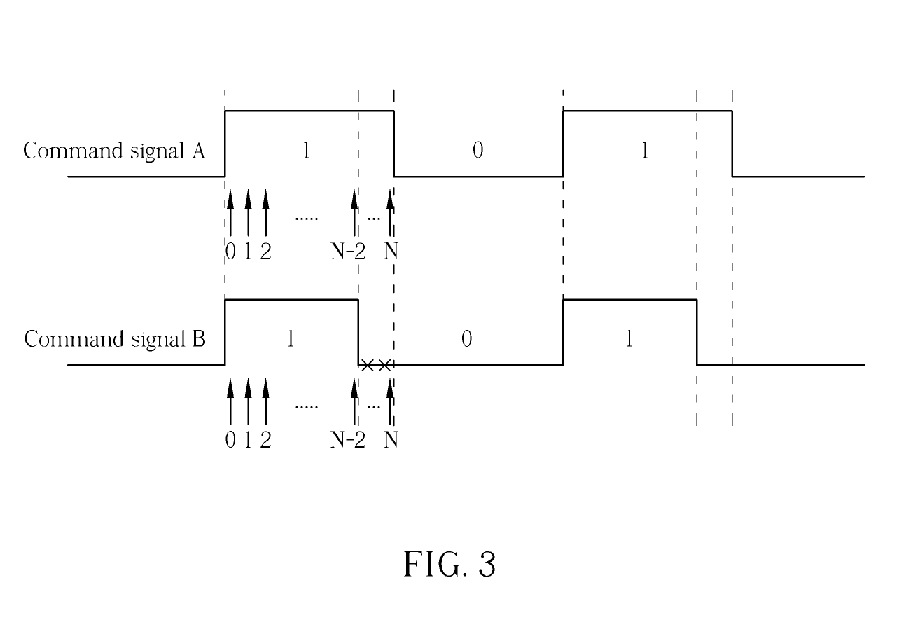

FIG. 3 is a schematic diagram illustrating a command signal sampling phase calibrating method according to one embodiment of the present application. In prior art, the duty cycle for the command signal is 50%. That is, time periods for the low level and the high level are the same, such as the command signal. By this way, the same results will be acquired no matter which phase between the phases 0-N is utilized to sample, thus it can not be determined which phase between the phases 0-N is suitable. Accordingly, in one embodiment of the present invention, the duty cycle of the command signal is adjusted such that the duty cycle thereof is not 50%, such as the command signal B. By this way, the sampling results for different phases may have difference. Take the command signal shown in FIG. 3 for example, phases N−2 to N are worse phases, therefore they can be omitted from selectable phases. By this way, it can be ensured that the command signal is transmitted via a better phase. In one embodiment, the command signal can be implemented by CMD13. According to SD spec, when the command received by the SD memory card is found to have CRC error, the response for the command should not be generated. The initial bit of the response is “0”, and hence the SD card controller can check if the command transceiving line has received “0” after a predetermined time period, to determine if the utilized phase then can let the SD memory card receives correct CMD13 or not.

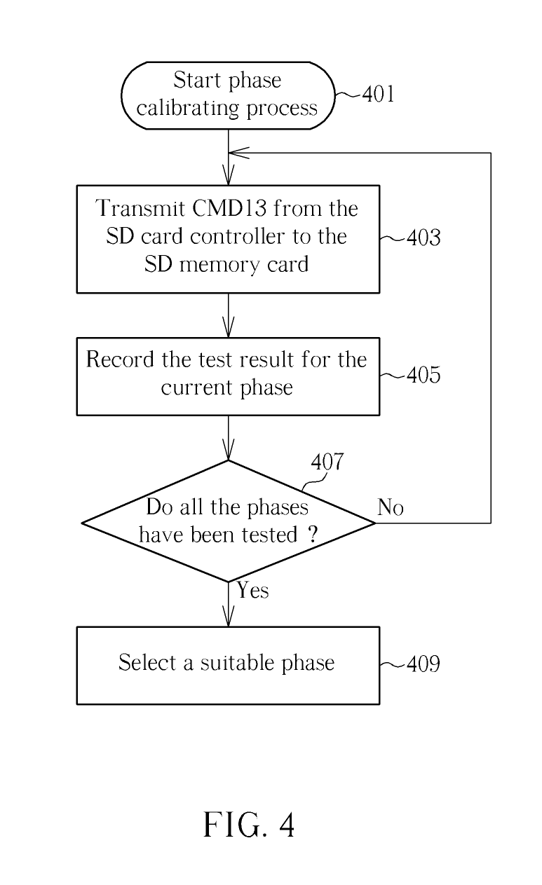

FIG. 4 is a flow chart illustrating a command signal sampling phase calibrating method according to one embodiment of the present application. As shown in FIG. 4, the method includes:

Step 401

Start phase calibrating process.

Step 403

Transmit CMD13 from the SD card controller to the SD memory card. AS described above, the duty cycle for CMD13 in the step 403 can be set to not equal to 50%. That is, time periods for the high level and the low level are different.

Step 405

Record the test result for the current phase.

Step 407

Determine if all the phases are tested. If yes, go to step 409, if not, go back to the step 403.

Step 409

Select a suitable phase.

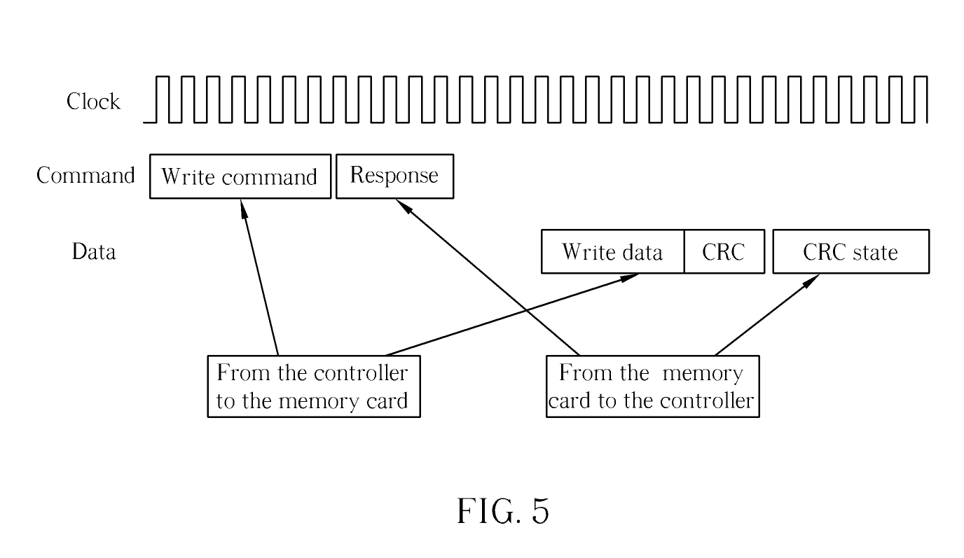

The data sampling phase calibrating method for writing data according to the embodiment of the present invention will be described as follows. Before the description, the relations between prior art relations between the clock signal, the command signal and the data signal will be described first. FIG. 5 is a schematic diagram illustrating prior art relations between the clock signal, the command signal and the data signal. The process for writing data can be shown as follows: The SD card controller transmits a writing command to the SD memory card, and the SD memory card transmits a response to the controller after receives the command. After the SD memory card calibrates the received data and CRC, the SD memory card transmits CRC state to inform the SD card controller if it successfully receives the data or not. The above-mentioned steps are accomplished in the case that the SD card controller provides synchronized clocks.

Based upon above-mentioned signals relations, the data sampling phase calibrating method for method transmitting according to one embodiment of the present invention is let the SD card controller transmits a command signal CMD27 to the SD memory card via a normal clock signal. Supporting for CMD27 is mandatory in SD spec, which provides a way for the SD card controller to modify the CSD (Card Specific Data) register of the SD card. The method shown in FIG. 3 and FIG. 4 can be applied here to select a most suitable phase for transmitting the command signal. Via the CMD27 command with variable transmitting phases, the SD card controller can determine if there is any error happens on the data transmitting in the signal channel between the SD card controller and the SD memory card according to the response and the CRC state acknowledged by the SD memory card. In order to make sure the SD card controller can acquire correct CSD register content, the SD card controller can utilize a slower clock to transmit a command signal CMD9 to acquire the content, before transmitting the command signal CMD27. The purpose for the slower clock is making sure the SD card controller can correctly read the content of the CSD register. According to the SD spec, if the SD memory card receives CMD27 and the received data has error for the CSD register content, the SD memory card will not update the CSD register. Therefore, the process for testing data transmitting phase according to the present embodiment can ensure that the original content of the SD memory card will not be amended. Also, in order to ensure the response and CRC state from the SD memory card can be correctly received by the SD card controller, the SD memory card can also response related information via a slower clock which is provided by the SD card controller.

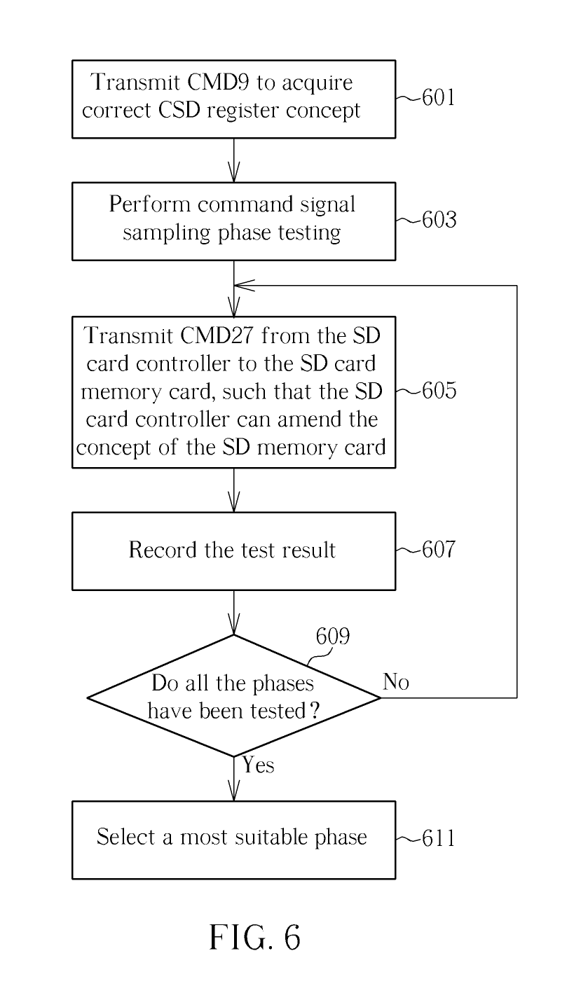

FIG. 6 is a flow chart illustrating a sampling phase calibrating method for data writing according to one embodiment of the present application, which includes the following steps:

Step 601

Transmit CMD9 to acquire correct CSD register content.

Step 603

Perform command signal sampling phase testing, that is, perform command signal sampling phases steps shown in FIGS. 3 and 4.

It should be noted that, the step 603 can be omitted in other embodiments, and only the steps 610, 605-611 are performed. Alternatively, the step 605 can be performed before performing the step 603.

Step 605

Transmit CMD27 from the SD card controller to the SD card memory card, such that the SD card controller can amend the content of the SD memory card (in this case, the content for the CSD register).

Step 607

Determine if data transmission has any error via examining the response from the SD memory card and the CRC state information, and record the test result.

Step 609

Determine if all the phases are tested. If yes, go to the step 611, if not, go back to the step 603.

Step 611

Select a most suitable phase.

The following description describes a sampling phase calibrating method for reading (receiving) data according to one embodiment of the present invention. One embodiment of the present invention lets the SD card controller to transmit the command signal ACMD13 to the SD memory card. ACMD13 is a command requesting support from the SD memory card in SD spec. The SD card controller acquires card status from the SD memory card via the command ACMD13. The SD memory card transmits response to the SD memory card controller via the command signal line after receives the ACMD13, and then transmits card status to the SD card controller via the data line. The CRC status is also included. The SD card controller can examine the data and the CRC state, and determines if the card status transmitted back by the data line is correct. Simultaneously, the SD card controller determines if the acceptance ability for the command signal has error or not, based on the response transmitted back by the SD memory card, which includes CRC state as well. If the response and the card status can both be correctly accepted, the data receiving ability for the current sampling phase is determined to be complete.

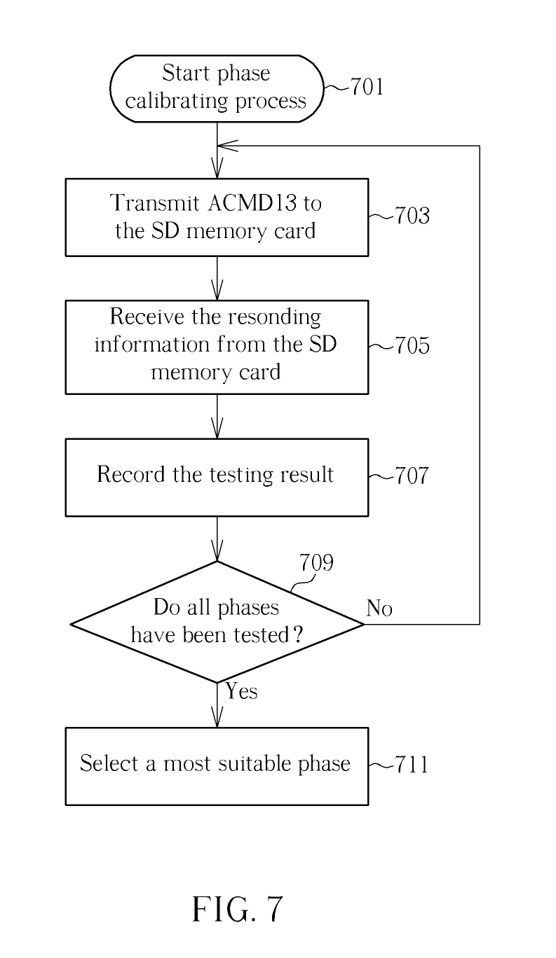

FIG. 7 is a flow chart illustrating a sampling phase calibrating method for data reading according to one embodiment of the present application.

Step 701

Start phase calibrating process.

Step 703

Let the SD card controller to transmit ACMD13 to the SD memory card.

Before this step, if it is not sure that the command signal can be correctly transmitted from the SD card controller to the SD memory card, the processes shown in FIG. 3 and FIG. 4 can be utilized to select a most suitable phase for transmitting a command signal.

Step 705

Let the SD card to receive the information responded by the SD card memory card, for example, the CRC state or the card state information. The content responded by the SD memory card is determined by which command signal is transmitted in the step 703.

Step 707

Record the testing result for the current phase.

Step 709

Determine if all phases are tested. If yes, go to step 711, if not, go back to the step 703.

Step 711

Select a most suitable phase.

It should be noted it is not limited that all phases must be tested and then select a most suitable phase. The most suitable phase can also be selected if only part of the phases are tested.

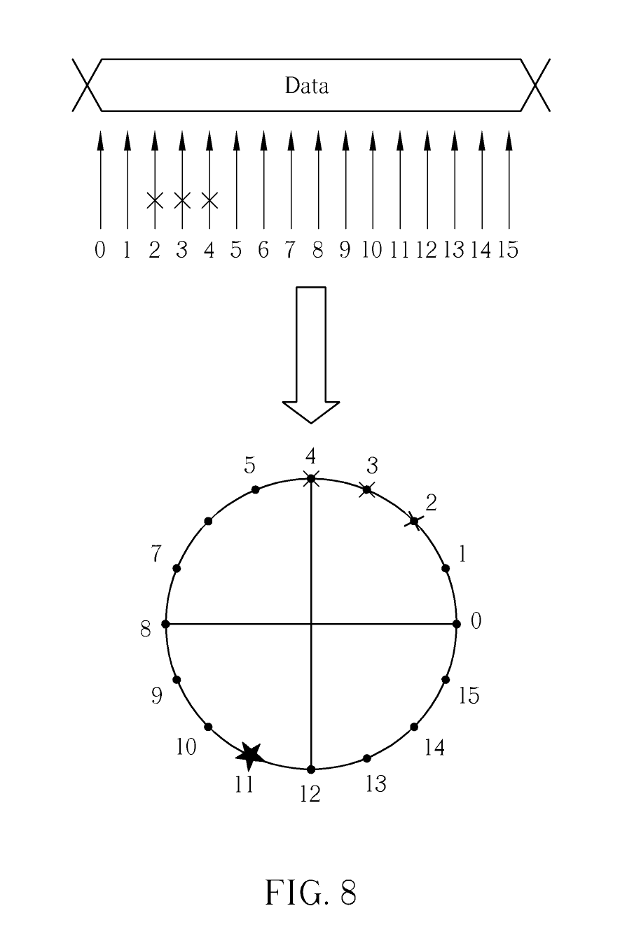

FIG. 8 is a schematic diagram illustrating how to select a proper sampling phase. One of the determining methods is: if a plurality of third sampling phases are determined to be suitable sampling phases, selecting the third sampling phase according to median sampling phases in a data sampling phase group having max number of continuous suitable sampling phases among the suitable sampling phases. Take FIG. 8 for example, the data sampling phases 0-1 and 5-15 are determined to be suitable data sampling phases (wherein the phase 15 and 0 can be regarded as continuous), then the median sampling phase (11) of the sampling phase group having max continuous suitable sampling phases (5→15→1)is a better sampling phase. For another example, if phases 0-2, 4-12 are determined to be suitable sampling phases, then the median sampling phase (8) of the sampling phase group having max continuous suitable sampling phases (4-12) is a better sampling phase. For still another example, if phases 0-1, 4-11 are determined to be suitable sampling phases, then the median sampling phase 7 or 8 of the sampling phase group having max continuous suitable sampling phases (4-11) is a better sampling phase. That is, if a number the sampling phase group having max continuous suitable sampling phases among the suitable sampling phases is N, and N is an odd number, then the better sampling phase is the (N+1)/2th sampling phase. On the contrary, if N is an even value, then the better sampling phase is the (N)/2th or(N)/2+1th sampling phase.

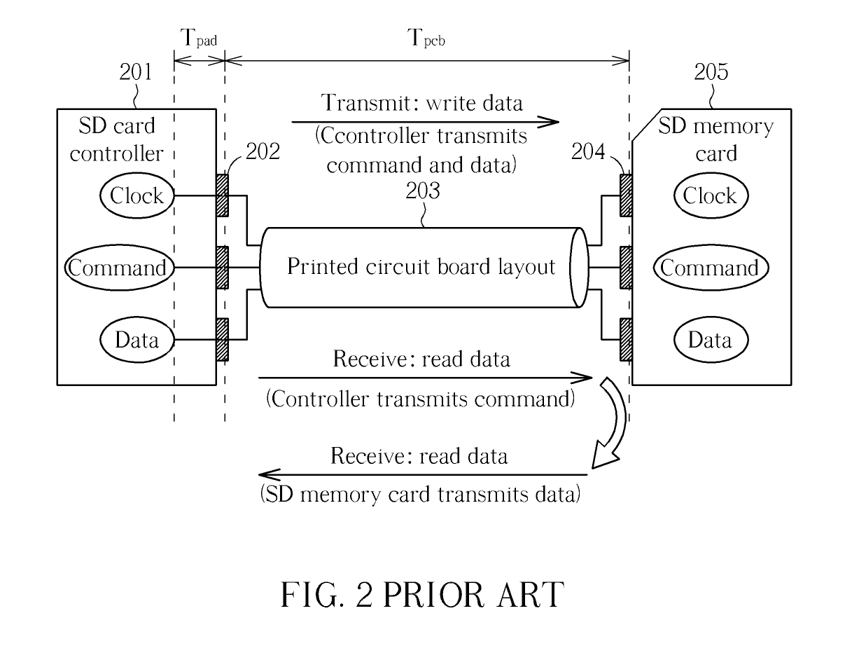

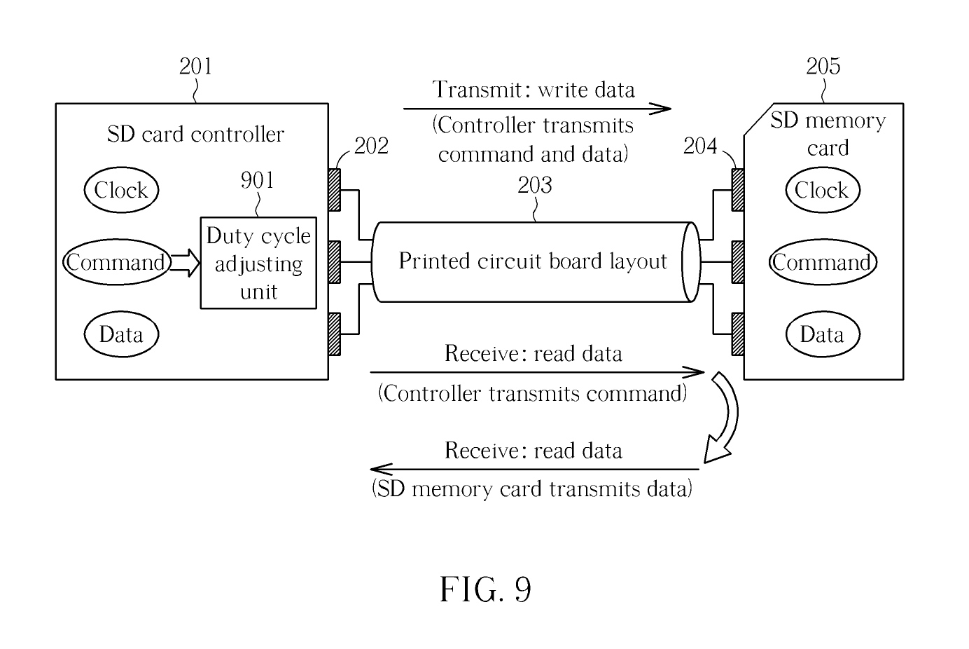

The above-mentioned calibrating method can be applied to a hardware shown in FIG. 2, which can be implemented by firmware. For example, the firmware can be written to the SD card controller 201 to perform above-mentioned calibrating methods. Also, the methods can be implemented by hardware. For example, a duty cycle adjusting unit can be provided to adjust the duty cycle of the command signal to perform the command signal sampling phase calibrating method, as shown in FIG. 9. Additionally, persons skilled in the art can apply above-mentioned calibrating method to other storage system according to the teaching disclosed by the embodiments of the present invention, which also falls in the scope of the present invention.

In view of above mentioned embodiments, the present invention provides a sampling phase calibrating method for data writing, to improve the defect of that prior art does not calibrating the sampling phase for data writing. Also, the command signal sampling phase calibrating method and the sampling phase for data reading are also provide. By this way, the data writing or reading can both be more accurate.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A sampling phase calibrating method, comprising:
transmitting a second command signal from a storage device controller to read content in a storage device;
transmitting a first command signal and a third data signal with a third sampling phase from the storage device controller to the storage device according to the content; and
determining if data transmitting from the storage device controller to the storage device has error according to responding information that the storage device responds to the storage device controller corresponding to the first command signal and the third data signal, to determine if the third sampling phase is suitable;
wherein the second command signal is transmitted via a second clock, the first command signal is transmitted via a first clock, where the second clock is slower than the first clock.

2. The sampling phase calibrating method of claim 1, wherein the response information is transmitted via a fourth clock, which is slower than the first clock.

3. The sampling phase calibrating method of claim 1, wherein the storage device is a SD memory card, the first command signal is a CMD27 command following a SD spec, the second command signal is a CMD9 command following the SD spec, where the content is stored in a CSD register.

4. The sampling phase calibrating method of claim 1, further comprising:
transmitting a third command signal from the storage device controller to the storage device; and
selecting a command sampling phase by changing time periods for a high level and a low level of the third command signal and according to a response that the storage device responds to the storage device controller corresponding to the third command signal;
wherein the second command signal is transmitted via the command signal sampling phase.

5. The sampling phase calibrating method of claim 1, further comprising:
selecting a third data sampling phase by changing time periods for a high level and a low level of the third data signal and according to the responding information.

6. The sampling phase calibrating method of claim 5, further comprising:
if a plurality of third sampling phases are determined to be suitable sampling phases, selecting the third sampling phase according to median sampling phases in a data sampling phase group having max number of continuous suitable sampling phases among the suitable sampling phases.

7. The sampling phase calibrating method of claim 1, further comprising:
transmitting a fifth command signal from the storage device controller to the storage device;
controlling the storage device to respond responding information to the storage device controller via a command signal line;
transmitting sixth data with a sixth sampling phase from the storage device to the storage device controller as six received data, via a data line; and
determining if the storage device controller correctly receives signals from the storage device according to the responding information and the six received data, to determine if the sixth sampling phase is suitable.

8. The sampling phase calibrating method of claim 7, wherein the fifth command signal is an ACMD13 command following a SD spec.

9. The sampling phase calibrating method of claim 7, further comprising:
selecting a sixth data sampling phase via changing time periods for a high level and a low level of the sixth data signal, and based on the responding information.

10. A sampling phase calibrating method, comprising:
transmitting a third command signal from a storage device controller to a storage device;
selecting a command sampling phase by changing time periods for a high level and a low level of the third command signal and according to a response that the storage device responds to the storage device controller corresponding to the third command signal;
transmitting a first command signal from a storage device controller with the command sampling phase to a storage device;
controlling the storage device to respond response information to the storage device controller via a command signal line;
transmitting third data with a third sampling phase from the storage device to the storage device controller as third received data, via a data line; and
determining if the storage device controller correctly receives signals from the storage device according to the responding information and the third received data, to determine if the third sampling phase is suitable.

11. The sampling phase calibrating method of claim 10, further comprising:
selecting a third data sampling phase by changing time periods for a high level and a low level of the third data signal and according to the responding information and the third received data.

12. The sampling phase calibrating method of claim 11, further comprising:
if a plurality of third sampling phases are determined to be suitable sampling phases, selecting the third sampling phase according to median sampling phases in a data sampling phase group having max number of continuous suitable sampling phases among the suitable sampling phases.

13. A storage system, comprising:
a storage device; and
a storage device controller, for transmitting a second command signal to read content in the storage device, and transmitting a first command signal and a third data signal with a third sampling phase to the storage device, and according to the content to determine if data transmitting from the storage device controller to the storage device has error and thereby determining if the third sampling phase is suitable;
wherein the storage device controller transmits the second command signal via a second clock, and transmits the first command signal via a first clock, where the second clock is slower than the first clock.

14. The storage system of claim 13, wherein the storage deice controller transmits a third command signal to the storage device, and selects a command sampling phase by changing time periods for a high level and a low level of the third command signal and according to a response that the storage device responds to the storage device controller corresponding to the third command signal; wherein the storage deice controller transmits the second command signal via the command sampling phase.

15. The storage system of claim 14, wherein storage device controller selects a third data sampling phase by changing time periods for a high level and a low level of the third data signal and according to the responding information.
